(19) United States
(12) Patent Application Publication
(10) Pub. No.: US 2021/0284509 A1
(43) Pub. Date: Sep. 16, 2021

(54) HOIST DRIVE SYSTEM

(71) Applicant: Wenger Corporation, Owatonna, MN (US)

(72) Inventors: Christopher D. Whaley, Phoenix, NY (US); Alvah B. Aldrich, Geneva, NY (US); Maximilian J. Sauer, Rochester, NY (US)

(21) Appl. No.: 16/820,171

(22) Filed: Mar. 16, 2020

(51) Int. Cl. B66D 1/56; B66D 1/20; B66D 1/58; B66D 1/48

(52) U.S. Cl. CPC B66D 1/56; B66D 1/20; B66D 5/14; B66D 1/48; B66D 1/58

(57) ABSTRACT

An innovative drive system for a hoist assembly is disclosed. The hoist drive system is designed to lift at fixed speeds or at variable speeds. The hoist drive system operates with little noise and provides for minimal maintenance during the life of the hoist that requires no lubrication, has superior environmental resistance, and a compact design.

### TECHNICAL FIELD

The present invention relates to hoist drive systems and assemblies. Specifically, the present invention relates to power transmission mechanisms for use with a hoist drive.

### BACKGROUND

Hoists, battens, and trusses are a critical element of performance venues such as theaters, concert halls, and auditoriums to move, elevate, or lower scenery, lighting, and other equipment around the venue. These lift systems must be capable of lifting and suspending heavy loads very quietly and smoothly as an integral part of the performance experience. Often, the lift systems are required to operate during a performance, increasing the importance of smooth and quiet operation. If the lift system is incapable of handling the requisite load capacities of heavy objects such as lighting fixtures, acoustic panels, scenery, or any other device to which the system may be attached, the system may pose a dangerous threat to the performers and audience. For many performances, the speed of the lift system is also important, to ensure that a creative vision is adequately portrayed by the movement of lights or scenery.

Some conventional hoist drive systems utilize ropes or cables to raise or lower a load. In these conventional systems, the ropes or cables are wound about a drum connected to a lift system motor. In these devices, the cables may rub unevenly against adjacent cables as they are being wound about and unwound from the drum. The uneven rubbing causes friction that may increase the rate at which the cables, drum, and other components need to be serviced or replaced. In addition, the friction can increase the noise of the system, which is undesirable in theatrical and staging environments. U.S. Pat. No. 8,317,159 to Hoffend, III (“Hoffend”) discloses a lift assembly drum that includes a cable management system capable of winding and unwinding cables in a smooth, controlled manner. Unfortunately, the Hoffend systems and methods still rely on cables or metal chains that mechanically couples the motor to the lifting mechanism.

Timing belts, also known as cambelts, are well known power transmission mechanisms, for example for their use as part of an internal combustion engine. In a combustion engine, timing belts are used to synchronize the rotation of the crankshaft and the camshaft. The toothed belt profile and toothed pulleys or sprockets help maintain system timing and can increase pulley density.

Timing belts have become a standard feature of automobile motor designs, because they improve the functionality of the motor and are lighter, cheaper, and quieter than chains. Many of the advantages of timing belts are because timing belts are made from soft, fibrous materials. The fibrous materials are easily damaged, for example when friction strips the teeth from the belt or delaminates portions of the belt until the fiber cores unravel. These failures led to a history of misuse in the performance industry, which shied away from implementing timing belts (and other “soft media” or flexible couplers) into hoists and lifting equipment.

Thus, there is desire in the performance industry for a lift system that can be driven by soft media. There is a need for a hoist drive system that operates in a smooth, controlled manner to minimize noise, friction, and operational damage. Finally, there is a need for a hoist drive system with a compact design capable of easy installation and use in a wide variety of venues.

### SUMMARY

Hoist drive systems according to the present disclosure are designed to provide a safe lifting mechanism for lighting, curtains, scenery, acoustic panels, or any other device to which the hoist can be attached. The hoist drive system is designed to lift at both fixed speeds of 20 ft/minute and at variable speeds up to 180 ft/minute. Embodiments of hoist drive systems according to the present disclosure are designed with load capacities of 1200 lbs to 2000 lbs. Embodiments are designed to meet or exceed the ANSI E1.6-1 standards.

The hoist drive system takes advantage of a belt device which connects the drive motor to the lifting drum. The belt device provides a soft media connection between the drive motor and the lifting drum, which are otherwise mechanically decoupled. The belt transmits lifting power through pulleys attached at the drive and driven ends of the system. The drive belt generally comprises a system of pulleys and a flexible coupler such as a belt formed of reinforced soft media, such as carbon fiber, Kevlar or steel belting construction, and is designed to meet or exceed the demands of the hoist system. For example, the belt may comprise a timing belt made of carbon fiber, reinforced steel construction that weaves the teeth into the structure of the belt itself. The construction of the belt ensures the belt is strong enough to withstand the load capacity and durable enough to ensure that friction does not damage the teeth or fibers of the belt. Alternatively, the flexible coupler may comprise a single or multi row roller chain.

An electromechanical brake system is attached directly to the drum side of the lifting system to provide a secondary fail-safe braking device when conditions exist or occur which would be potentially hazardous to the system, the hoist, the arbor, the building, or nearby people or operators of the system. The electromechanical brake system generally comprises a rotary limit switch with an integrated encoder and a secondary brake disc. The rotary limit switch is configured to monitor the rotational speed of the lifting drum and communicate with an integrated encoder coupled with the motor to ensure both are rotating at the proper speed. If secondary braking system's digital comparison of the rotational speeds of the lifting drum and the motor indicates the system is deviating from the programmed parameters, the limit switch activates the electromechanical brake to stop the motor.

The above summary is not intended to describe each illustrated embodiment or every implementation of the subject matter hereof. The figures and the detailed description that follow more particularly exemplify various embodiments.

### ADVANTAGES OF THE INVENTION

Minimal noise emitted during system operation.

Minimal maintenance required during system lifetime.

Flexible belt power transmission mechanism does not require lubrication, improving ease of operation and reducing operating costs.

High strength construction designed for superior environmental resistance.

Compact design permits use and installation in a wide variety of venues.

Secondary fail-safe brake system monitoring rotation of the lifting drum enhances safety.

### BRIEF DESCRIPTION OF THE DRAWINGS

Subject matter hereof may be more completely understood in consideration of the following detailed description of various embodiments in connection with the accompanying figures, in which:

FIG. 1 is a sideview of the hoist drive system according to an embodiment of the invention;

FIG. 2 is a perspective view of the hoist drive system according to an embodiment of the invention;

FIG. 3 is an elevation view of the hoist drive system according to an embodiment of the invention;

FIG. 4 is a perspective view of the hoist drive system according to an embodiment of the invention;

FIG. 5 is an elevation view of the hoist drive system according to an embodiment of the invention;

FIG. 6 is a side view of the hoist drive system according to an embodiment of the invention;

FIG. 7 is a side view of the hoist drive system according to an embodiment of the invention;

FIG. 8 is a side view of the hoist drive system according to an embodiment of the invention.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

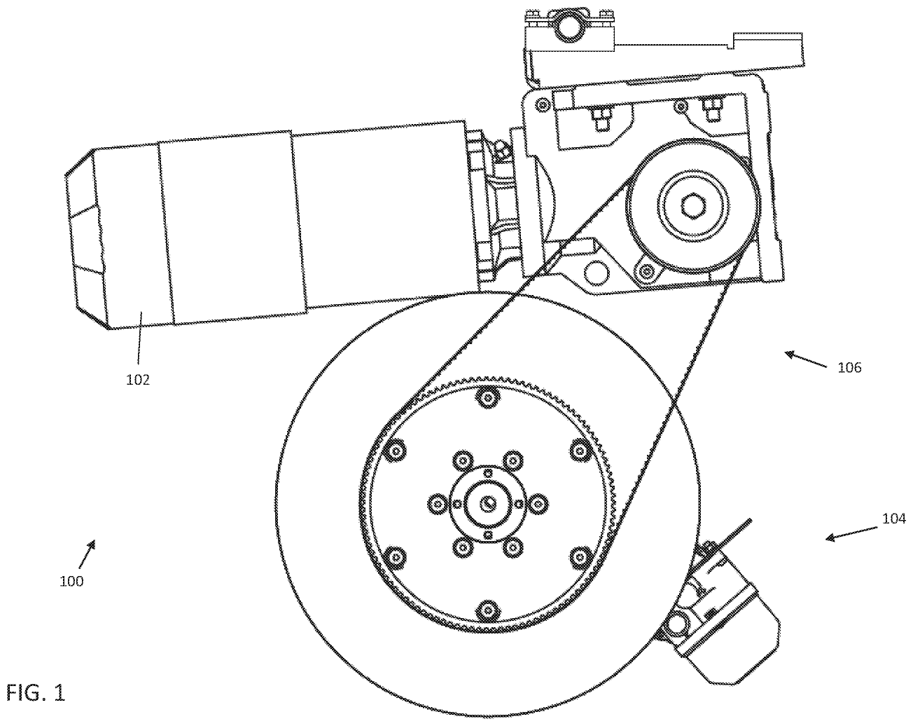

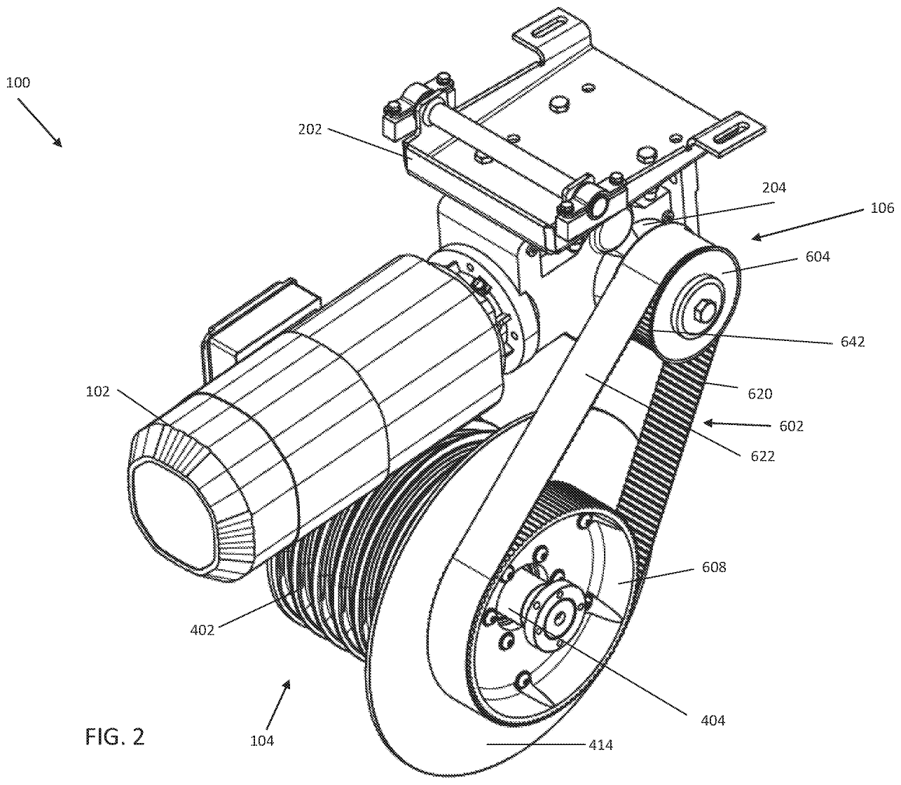

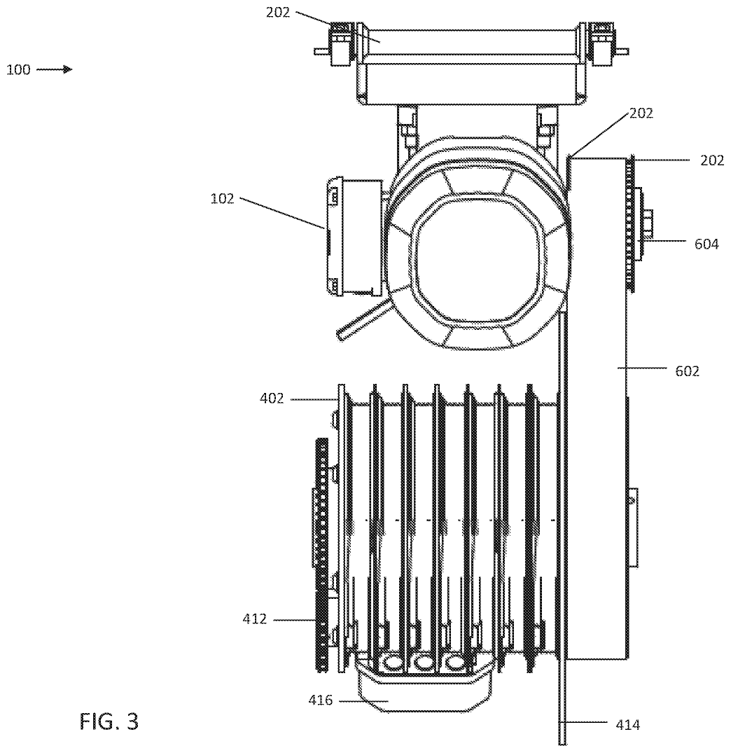

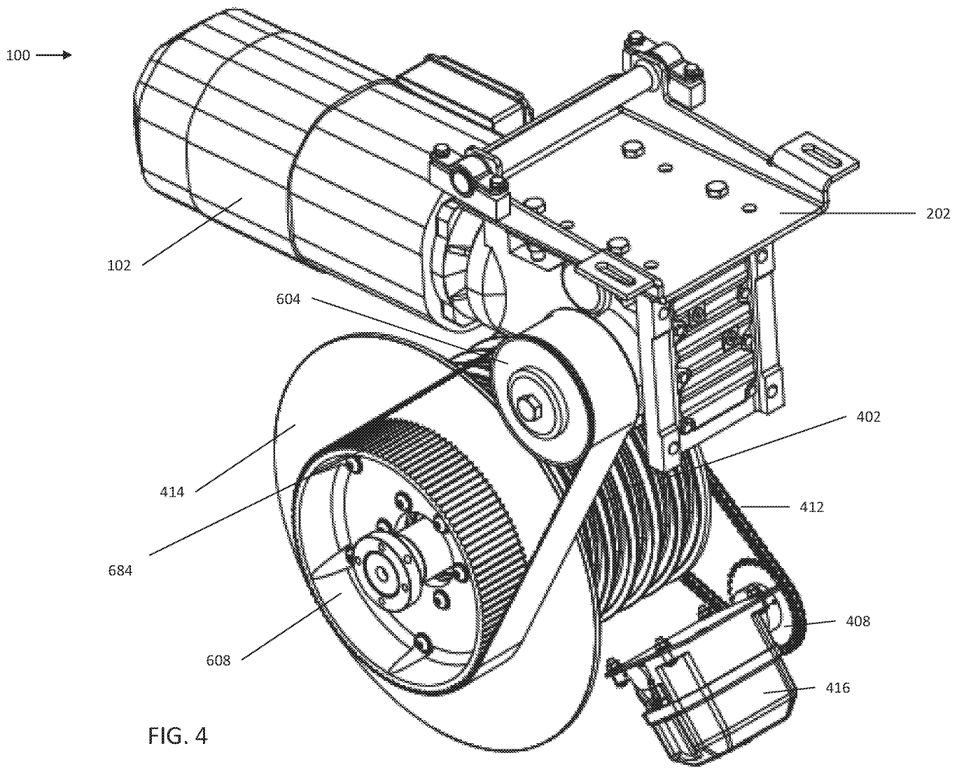

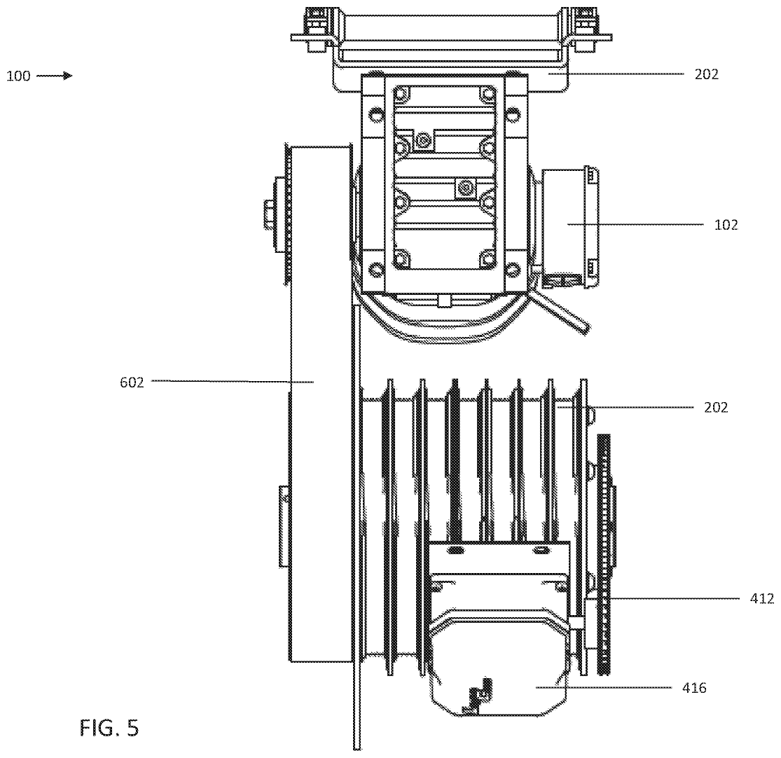

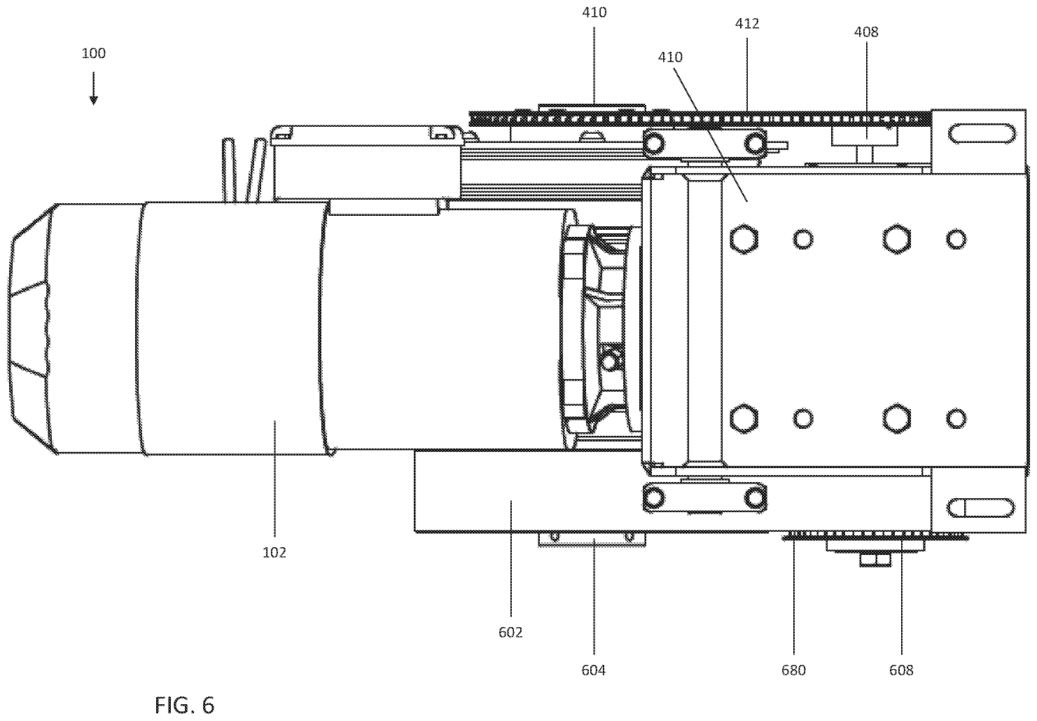

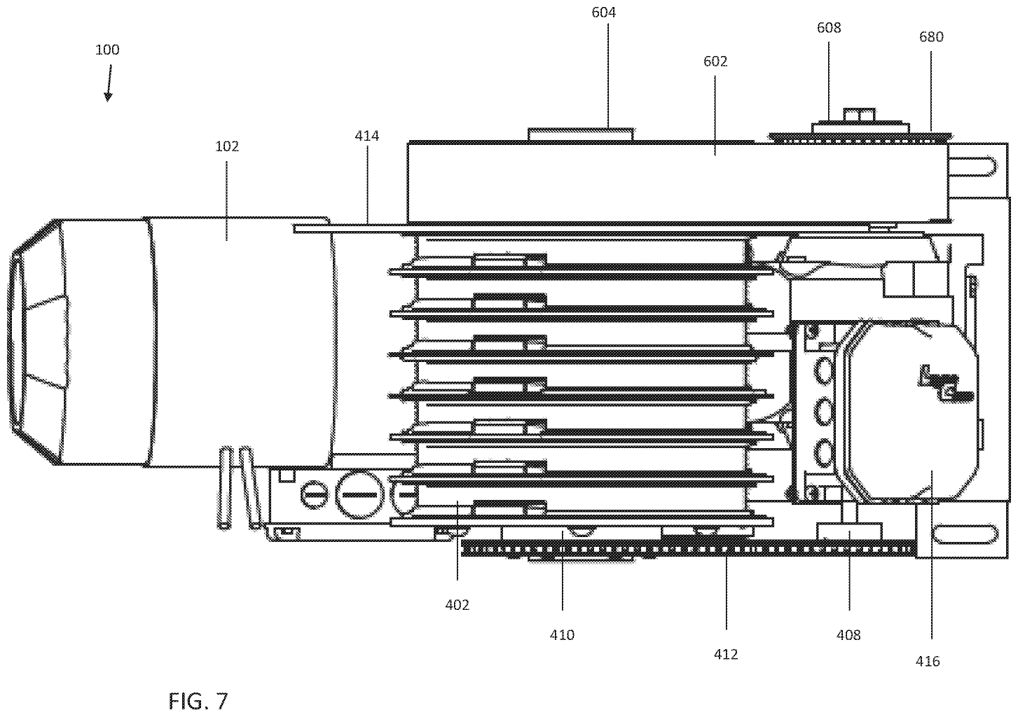

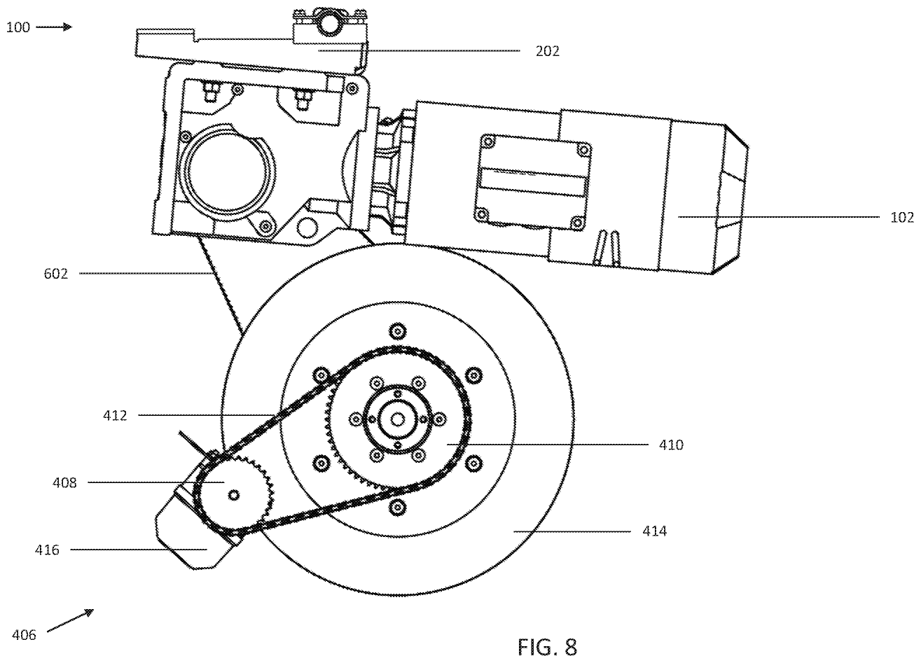

A hoist drive system according to an embodiment of the invention is depicted generally in FIGS. 1-8 with reference numeral 100. Drive system 100 generally comprises a motor 102 linked to a drum assembly 104 via a soft media connection such as a belt drive 106. Motor 102 is mechanically decoupled from the drum assembly 104, meaning throughout this disclosure that there is no direct connection (e.g., shaft or chain) between the driving media and the lifting or movement media of drive system 100. Belt drive 106 uses a soft media connection to transfer power from motor 102 to drum assembly 104.

The hoist drive system is designed to lift at both fixed speeds of 20 ft/minute and at variable speeds up to 180 ft/minute. Embodiments of hoist drive systems according to the present disclosure are designed with load capacities of 1200 lbs to 2000 lbs. Embodiments are designed to meet or exceed the ANSI E1.6-1 standards.

In embodiments, motor 102 is coupled to a pivoting mount 202 permitting installation of drive system 100 within a hoist or lifting assembly. Motor 102 also generally includes a motor shaft 104 that couples motor 102 with belt drive 106 and an integrated encoder 206 (not shown in the figures). Motor shaft 104 transfers power generated by motor 102 to a driving pulley 604 of belt drive 106.

Embodiments of belt drive 106 generally comprise driving pulley 604, flexible coupler 602, and driven pulley 608. Flexible coupler may comprise, for example, a timing belt or other belt device, or a single or multi row roller chain. In embodiments, driving pulley 604 is mechanically coupled to motor shaft 204 such that power produced by motor 102 rotates driving pulley 604. Embodiments of driving pulley 604 may also include flanges 644. Flanges 644 are arranged proximate the edges of driving pulley 604 to ensure flexible coupler 602 does not disconnect from driving pulley 604. Embodiments of driving may also include a plurality of teeth 642 configured for operable coupling with a toothed surface 620 of flexible coupler 602.

Some embodiments of flexible coupler 602 comprise a band of material having a toothed surface 620 opposite a smooth surface 622. Toothed surface 620 is configured to complement the plurality of teeth 642 arranged on driving pulley 604 and a plurality of teeth 684 arranged on driven pulley 608. Toothed surface 620 thus contacts each of driving pulley 604 and driven pulley 608. Alternatively, flexible coupler 602 comprises a band of material with opposing smooth surfaces, in which case the plurality of teeth 642 on driven pulley 604 and the plurality of teeth 684 on driving pulley 608 may be adjusted accordingly. For example, flexible coupler 602 may comprise a single or multi row roller chain operably coupled with appropriate pulley devices.

Physical contact between flexible coupler 602 and each of driving pulley 604 and driven pulley 608 provides the soft media connection that transfers power from motor 102 to drum assembly 104. Embodiments of flexible coupler 602 are generally formed of reinforced soft media, such as carbon fiber, Kevlar or steel belting construction, designed to meet or exceed the demands of the hoist system. For example, flexible coupler 602 may have a carbon fiber, reinforced steel construction that weaves the plurality of teeth 620 into the structure of flexible coupler 602 itself. The construction of flexible coupler 602 ensures flexible coupler 602 is strong enough to withstand the load capacity and durable enough to ensure that friction does not damage the plurality of teeth 620 or fibers of flexible coupler 602.

In embodiments, driven pulley 608 is mechanically coupled to drum assembly 410 such that rotation of driven pulley 608 provides power to drum assembly 104. Embodiments of driving pulley 604 also include a plurality of teeth 684 arranged to complement toothed surface 620 of flexible coupler 602. Some embodiments of driven pulley 608 additionally include at least one flange 680, analogous to flanges 644 of driving pulley 604. In alternative embodiments, driven pulley 608 does not include flanges, and the connection with flexible coupler 602 is maintained by the plurality of teeth 684 and the tension in flexible coupler 602.

Drum assembly 104 generally includes a lifting drum 402, a drum shaft 404, and a secondary brake system 406. Drum shaft 404 protrudes from lifting drum 402 permitting mechanical coupling with driven pulley 608. Drum shaft 404 also protrudes from the opposite side of lifting drum 402 permitting mechanical coupling with secondary brake system 406. Embodiments of lifting drum 402 may comprise any appropriate hoisting or lifting mechanism, as recognized by a person of skill in the art.

Secondary brake system 406 generally comprises a limit switch pulley 408, a drum pulley 410, a roller chain 412, a secondary brake disc 414, and a rotary limit switch 416. Embodiments of secondary brake disc 414 may be attached to drum assembly 104 proximate driven pulley 608. Secondary brake disc 414 may comprise the at least one flange 680 of driven pulley 608. In embodiments, drum pulley 410 is rotatably coupled to lifting drum 402 opposite driven pulley 608. Roller chain 412 mechanically couples drum pulley 410 with limit switch pulley 408, in an arrangement similar to the arrangement of belt drive 106.

Another embodiment of the invention includes a means of providing additional monitoring and control of the movement of lifting drum 402. As shown in FIGS. 1, 3-5, 7, and 8, secondary brake system 406 includes a rotary limit switch 416 with integrated encoder (not shown) that monitors the rotation of lifting drum 402 relative to the rotation of motor 102. Rotary limit switch 416 also includes a limit switch pulley 408 operably connected by a roller chain 412. Persons skilled in the art will recognize that roller chain 412 may comprise any appropriate drive chain, and embodiments are not limited to exact replications of roller chain 412.

Through an algorithm in the secondary brake system 406, the encoder count is used to calculate the position of the cable travel based on the diameter growth created from the cable building up on lifting drum 402. This system is similar to U.S. Pat. No. 8,328,165, which is incorporated herein by reference in its entirety.

By taking into account the number of cable wraps per layer, the diameter of the cable, and the diameter of each layer, and accounting for the ratio difference between each encoder and the speed ratio of motor 102 and the ratio introduced by the ratio between drum pulley 410 and limit switch pulley 408, a greatly increased accuracy of monitoring and control is established.

For example, a ratio of 3,600 revolutions of rotary limit switch 416 per lifting drum 402 can be accomplished. When the secondary brake system 406 indicates variations between the actual lifting drum 402 rotation and expected values from motor 102 rotation outside of acceptable limits, secondary brake system 406 can shut down motor 102. This feature acts as a fail-safe to a primary brake system with which hoist drive system 100 may be installed in a hoist or lifting assembly (for example via pivoting mount 202).

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

What is claimed is:

1. A hoist drive system comprising:
a motor configured to transmit power to a drum assembly having a lifting drum via a belt drive, wherein the belt drive provides a soft media power transmission between the motor and the drum assembly, and wherein the drum assembly is attached to a secondary brake configured to stop the power transmission from the motor to the drum assembly by stopping the movement of the lifting drum.

2. The hoist drive system of claim 1, wherein the soft media power transmission comprises a timing belt operably coupled to a driving pulley rotatably coupled to the motor and to a driven pulley rotatably coupled to the drum assembly.

3. The hoist drive system of claim 2, wherein the timing belt is a toothed timing belt and the driving pulley further comprises at least one flange configured to stabilize the toothed timing belt in an operable position on the driving pulley.

4. The hoist drive system of claim 2, wherein the timing belt comprises a carbon fiber material with a reinforced steel weave construction that integrates a plurality of teeth of the timing belt directly into a body of the timing belt.

5. The hoist drive system of claim 2, wherein the timing belt comprises a strong synthetic fiber material having a reinforced steel weave construction.

6. The hoist drive system of claim 1, wherein the soft media power transmission comprises a flexible coupler.

7. The hoist drive system of claim 1, wherein the motor and the drum assembly are mechanically decoupled except for the soft media connection provided by the belt drive.

8. The hoist drive system of claim 1, further comprising:
a secondary brake disc operably attached to the drum assembly proximate the belt drive; and
a rotary limit switch having an integrated encoder in communication with an integrated encoder of the motor, wherein the rotary limit switch is coupled to the lifting drum opposite from the secondary brake disc, and wherein the integrated encoder of the rotary limit switch is configured to monitor a rotational speed of the lifting drum and perform a digital comparison of the rotational speed with a power input level provided by the integrated encoder of the motor.

9. The hoist drive system of claim 8, wherein the secondary brake disc is configured to stabilize the position of the soft media connection proximate the lifting drum.

10. The hoist drive system of claim 1, further comprising:
a pivoting mount coupled to the motor and configured to attach the hoist drive system with a hoist assembly.

11. The hoist drive system of claim 1, wherein the drum assembly is configured to operate at either a fixed speed or a variable speed.

12. The hoist drive system of claim 1, wherein the drum assembly has a load capacity range of 1200 lbs. to approximately 2000 lbs.

13. A hoist drive comprising:
a motor;
a lifting drum assembly; and
a flexible power transmission mechanism configured to transmit power from the motor to the lifting drum assembly, wherein the flexible power transmission comprises a band of strong synthetic fiber material having a reinforced steel weave construction operably coupled to a driving pulley rotatably attached to the motor, and wherein the band is operably coupled to a driven pulley rotatably attached to the lifting drum assembly.

14. The hoist of claim 13, the lifting drum assembly further comprising a secondary brake assembly configured to stop the power transmission from the motor to the drum assembly by stopping the movement of the lifting drum assembly.

15. The hoist drive of claim 14, further comprising:
a lifting drum having a first side and a second side, wherein the flexible power transmission mechanism is rotatably coupled to the lifting drum at the first side proximate a secondary brake disc; and
a rotary limit switch having an integrated encoder in communication with an integrated encoder of the motor, wherein the rotary limit switch is coupled to the second side of the lifting drum.

16. The hoist drive of claim 15, wherein the integrated encoder of the rotary limit switch is configured to monitor a rotational speed of the lifting drum and perform a digital comparison of the rotational speed with a power input level provided by the integrated encoder of the motor.

17. The hoist drive of claim 16, wherein the secondary brake disc is configured to stabilize the position of the soft media connection proximate the lifting drum.

18. The hoist drive of claim 13, further comprising:
a pivoting mount coupled to the motor.

19. The hoist drive of claim 13, wherein the lifting drum assembly is configured to operate at either a fixed speed or a variable speed.

20. The hoist drive of claim 13, wherein the lifting drum assembly has a load capacity range of 1200 lbs. to approximately 2000 lbs.

21. The hoist drive of claim 13, wherein the motor and the lifting drum assembly are mechanically decoupled except for the band.

22. The hoist drive of claim 13, wherein the band comprises a timing belt.

23. The hoist drive of claim 22, wherein the timing belt is a toothed belt and the driving pulley further comprises at least one flange configured to stabilize the toothed belt in an operable position on the driving pulley.

24. The hoist drive of claim 22, wherein the band comprises a carbon fiber material with a reinforced steel weave construction that integrates a plurality of teeth of the timing belt directly into a body of the timing belt.

25. The hoist drive of claim 13, wherein the band comprises a carbon fiber material having a reinforced steel weave construction.

26. A method of hoisting comprising:
providing a hoist drive system comprising:
a motor configured to transmit power to a drum assembly having a lifting drum via a belt drive, wherein the belt drive provides a soft media connection between the motor and the drum assembly, the drum assembly attached to a secondary brake configured to stop the power transmission from the motor to the drum assembly by stopping the movement of the lifting drum.

27. The method of hoisting of claim 26, further comprising:
operating the hoist drive system at a fixed speed.

28. The method of hoisting of claim 26, further comprising:
operating the hoist drive system at a variable speed.

29. The method of hoisting of claim 26, wherein the drum assembly has a load capacity range of 1200 lbs. to approximately 2000 lbs.

30. A method of driving a hoist, comprising:
providing a hoist drive comprising:
a motor;
a lifting drum assembly; and
a flexible power transmission mechanism configured to transmit power from the motor to the lifting drum assembly, wherein the flexible power transmission comprises a band of strong synthetic fiber material having a reinforced steel weave construction operably coupled to a driving pulley rotatably attached to the motor, and wherein the band is operably coupled to a driven pulley rotatably attached to the lifting drum assembly.

31. The method of driving a hoist of claim 30, further comprising:
monitoring a rotational speed of the lifting drum assembly via a rotary limit switch having an integrated encoder in communication with an integrated encoder of the motor, wherein the integrated encoder of the motor is capable of being programmed to receive an operating parameter;
digitally comparing the rotational speed with the operating parameter; and
stopping the hoist by activating a secondary brake disc operably coupled to the lifting drum assembly proximate the driven pulley.
